(19) United States
(12) Patent Application Publication
(10) Pub. No.: US 2020/0270027 A1
(43) Pub. Date: Aug. 27, 2020

(54) PACKAGING STRUCTURE WITH PATTERNS FORMED THROUGH CONTINUOUS MULTI-COLOR HOT FOIL STAMPING

(71) Applicant: ALL PACKING ENTERPRISES CO., LTD., Taoyuan City (TW)

(72) Inventor: SHIH-CHING YEH, TAOYUAN CITY (TW)

(21) Appl. No.: 16/285,897

(22) Filed: Feb. 26, 2019

(51) Int. Cl. B65D 33/00; B44C 1/17

(52) U.S. Cl. CPC B65D 33/004; B65D 2203/00; B44C 1/1729

(57) ABSTRACT

A packaging structure with patterns formed through continuous multi-color hot foil stamping includes a packaging portion consisting of a receiving unit and a bottom panel, and a pattern portion located on an outer surface of the packaging portion and including continuous multi-color hot foil stamped areas. The receiving unit internally defines at least one holding space and has a first and a second opening respectively formed at a top and a bottom thereof and communicable with the holding space. The bottom panel is an integral one-piece member connected to the bottom of the receiving unit to close the second opening. The one-piece bottom panel allows the bottom of the packaging portion to have a flat and seamless middle area and accordingly, increased overall structural stability. Since the pattern portion includes continuous multi-color hot foil stamped areas, it can be formed in a quick, low-cost and aesthetic manner.

### FIELD OF THE INVENTION

The present invention relates to a packaging structure with patterns formed through continuous multi-color hot foil stamping, and more particularly, to a packaging structure that includes patterns formed through continuous multi-color hot foil stamping and has increased overall structural stability, and can be manufactured in a quick, low-cost and aesthetic manner.

### BACKGROUND OF THE INVENTION

Conventionally, a packaging structure is made of a paper or a plastic material, and includes a bottom having a material joint formed at a middle area thereof. The packaging structure with the material joint formed at the middle bottom area tends to have relatively weak structural stability and is subjected to the risk of separating apart along the material joint in a heavily loaded or wetted condition.

Further, to make differently configured packaging structures or to present patterns at different locations on the packaging structures or in different typefaces or fonts, different molds are required. The patterns, either two-dimensional or hollowed-out, are normally printed or stamped on a packaging material before the latter is further processed or folded to form a packaging structure. Therefore, the conventional packaging structures are manufactured at a relatively slow speed, and the patterns thereof are subjected to damage or deviation in positions during subsequent processing, rendering the packaging structures defective products and accordingly, resulting in increased mold, material and labor costs.

It is therefore tried by the inventor to develop a packaging structure that includes patterns formed through continuous multi-color hot foil stamping, so that the packaging structure can have increased overall structural stability and can be manufactured in a quick, low-cost and aesthetic manner to effectively improve the conventional packaging structures.

### SUMMARY OF THE INVENTION

A primary object of the present invention is to overcome the disadvantages in the conventional packaging structures by providing a packaging structure that includes patterns formed through continuous multi-color hot foil stamping and has increased overall structural stability, and can be manufactured in a quick, low-cost and aesthetic manner.

To achieve the above and other objects, the packaging structure with patterns formed through continuous multi-color hot foil stamping according to the present invention includes a packaging portion and a pattern portion. The packaging portion includes a receiving unit and a bottom panel. The receiving unit internally defines at least one holding space and has a first opening and a second opening respectively formed at a top and a bottom of the receiving unit and communicable with the holding space. The bottom panel is an integral one-piece member connected to the bottom of the receiving unit to close the second opening. The pattern portion is located on an outer surface of the packaging portion and includes continuous multi-color hot foil stamped areas.

In the packaging structure of the present invention, the receiving unit consists of two face panels located opposite to each other and two side panels located opposite to each other. The two side panels are connected at respective two lateral edges to the lateral edges of the two face panels; and the bottom panel is connected at its two side edges to lower side edges of the two face panels and at its two end edges to lower end edges of the two side panels, such that the bottom panel closes the second opening of the receiving unit.

In the packaging structure of the present invention, joints between the face panels and the side panels are heat sealed; and joints between the bottom panel and the face panels and side panels are also heat sealed.

In the packaging structure of the present invention, the packaging portion is internally provided at a position near the first opening with a re-sealable section; and the re-sealable section can be a zip lock, a hook-and-loop fastener, a heat-sealable layer or a pair of mating fasteners.

The packaging structure of the present invention further includes a protective layer provided on an outer side of the packaging portion; and the protective layer is attached to at least the pattern portion.

In the packaging structure of the present invention, the packaging portion is made of a material selected from the group consisting of a paper material, an aluminum foil material, a plastic material, and any combination thereof.

In the packaging structure of the present invention, the packaging portion is provided in the vicinity of the first opening with at least a pair of handles.

In an embodiment of the packaging structure of the present invention, the packaging portion is provided in the vicinity of the first opening with two corresponding openings, and the two openings form the pair of handles.

In another embodiment of the packaging structure of the present invention, the packaging portion is provided at a top with two straps, and the two straps form the pair of handles.

In an operable embodiment of the packaging structure of the present invention, the pattern portion includes hollow-out areas formed on the packaging portion by laser cutting; and the packaging portion are internally provided with at least one sheet of plastic film for closing the hollow-out areas of the pattern portion.

In another operable embodiment of the packaging structure of the present invention, the pattern portion includes embossed areas, extruded areas or combined high and low relief areas, or any combination thereof, which are formed on the outer surface of the packaging portion.

In the packaging structure with patterns formed through continuous multi-color hot foil stamping according to the present invention, the one-piece bottom panel allows the bottom of the packaging portion to have a flat and seamless middle area and accordingly, increased overall structural stability. And, since the pattern portion includes continuous multi-color hot foil stamped areas, it can be formed in a quick, low-cost and aesthetic manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a packaging structure with patterns formed through continuous multi-color hot foil stamping according to a first embodiment of the present invention;

FIG. 2 is an exploded view of FIG. 1;

FIG. 3 is an assembled perspective view of a packaging structure with patterns formed through continuous multi-color hot foil stamping according to a second embodiment of the present invention;

FIG. 4 is a fragmentary, assembled perspective view of a packaging structure with patterns formed through continuous multi-color hot foil stamping according to a third embodiment of the present invention; and

FIG. 5 is a fragmentary, assembled perspective view of a packaging structure with patterns formed through continuous multi-color hot foil stamping according to a fourth embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

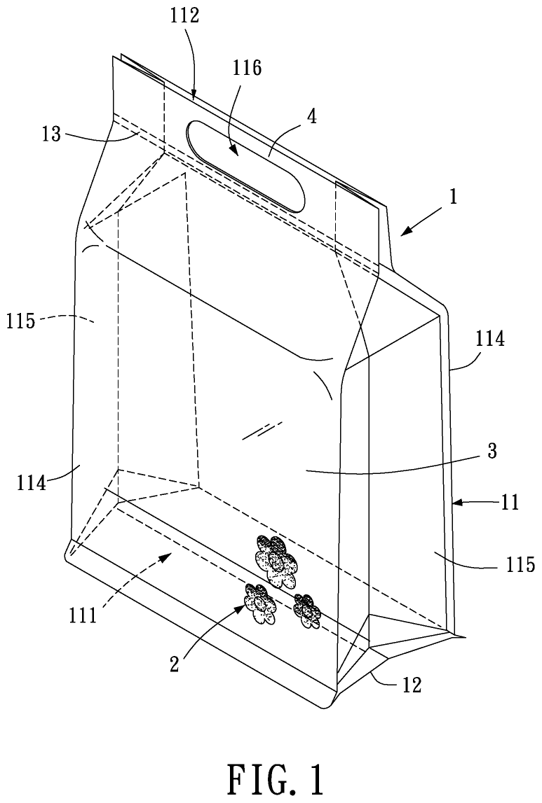

Please refer to FIGS. 1 to 5, in which different embodiments of a packaging structure with patterns formed through continuous multi-color hot foil stamping according to the present invention are shown. As shown, the packaging structure with patterns formed through continuous multi-color hot foil stamping according to the present invention includes at least a packaging portion 1 and a pattern portion 2. Meanwhile, for the purpose of conciseness and clarity, the present invention is also briefly referred to as the packaging structure herein.

The packaging portion 1 is formed of a receiving unit 11 and a bottom panel 12.

The receiving unit 11 internally defines at least one holding space 111 and has a first opening 112 and a second opening 113, which are formed at a top and a bottom of the receiving unit 11, respectively, and communicable with the holding space 111. The bottom panel 12 is an integral one-piece member connected to the bottom of the receiving unit 11 to close the second opening 113.

The pattern portion 2 is located on an outer surface of the packaging portion 1 and includes continuous multi-color hot foil stamped areas. The pattern portion 2 can show texts, numeral numbers, graphics, or any combination thereof; and the continuous multi-color hot foil stamped areas are molded on the surface of the packaging portion 1 through continuously hot stamping foils of different colors on the packaging portion 1.

Before making a complete receiving unit 11 of the packaging portion 1, first form the continuous multi-color hot foil stamped areas on the unformed receiving unit 11 to provide the pattern portion 2. The pattern portion 2 can be formed on only one of a front, a rear, a left and a right surface of the packaging portion 1, or be formed on all of the front, rear, left and right surfaces of the packaging portion 1. Since the pattern portion 2 is formed by continuous multi-color hot foil stamped areas, a colorful and gradient effect can be created on the pattern portion 2 in a quick, low-cost and aesthetic manner.

After a complete receiving unit 11 of the packaging portion 1 is formed, the one-piece bottom panel 12 is connected to the bottom of the receiving unit 11 to close the second opening 113. To use the packaging structure of the present invention, articles can be positioned into the holding space 111 of the receiving unit 11 via the first opening 112. Since the bottom panel 12 of the packaging portion 1 is a one-piece member, it gives the packaging portion 1 a bottom having a flat and seamless middle area, which allows the packaging portion 1 to withstand a relatively heavy load without the risk of becoming separated apart at any joint on the bottom panel due to the heavy load or a whetted condition. Thus, the packaging portion 1 has increased overall structural stability.

The receiving unit 11 consists of two face panels 114 and two side panels 115. The two face panels 114 are disposed opposite to each other; and the two side panels 115 are connected at respective two lateral edges to the lateral edges of the two face panels 114. Further, the bottom panel 12 is connected at its two side edges to lower side edges of the two face panels 114 and at its two end edges to lower end edges of the two side panels 115, so that the bottom panel 12 closes the second opening 113 of the receiving unit 11 for the packaging portion 1 to form a bag. With the bag-shaped packaging portion 1, articles can be positioned in the holding space 111. The bottom panel 12, the face panels 114 and side panels 115 connected to one another give the receiving unit 11 of the packaging portion 1 an increased overall structural stability, while the pattern portion 1 gives the packaging portion 1 an aesthetic appearance.

The joints between the face panels 114 and the side panels 115 are heat sealed; and the joints between the bottom panel 12 and the face panels 114 and side panels 115 are also heat sealed. In this manner, it is able to further increase the overall structural stability of the packaging portion 1.

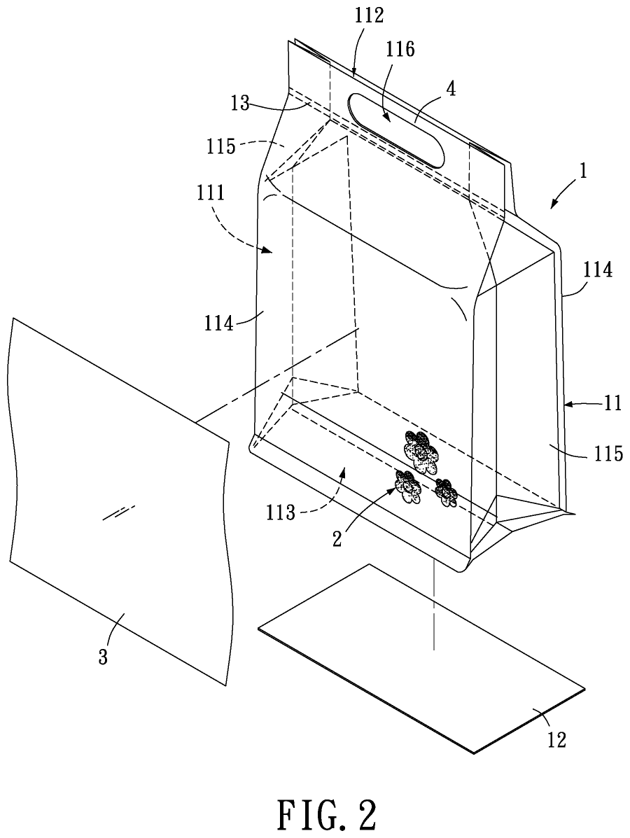

The packaging portion 1 is internally provided at a position near the first opening 112 with a re-sealable section 13, as can be seen in FIGS. 1 and 2. The re-sealable section 13 can be a zip lock, a hook-and-loop fastener, a heat-sealable layer (in the case the packaging portion 1 has a plastic interior), or a pair of mating fasteners. In the illustrated embodiments, the re-sealable section 13 is a zip lock. With the re-sealable section 13, the first opening 112 can be repeatedly closed and opened. When the re-sealable section 13 closes the first opening 112, articles positioned in the holding space 111 are prevented from falling out of the packaging structure. Besides, the re-sealable section 13, no matter in the form of a zip lock, a hook-and-loop fastener or a pair of mating fasteners, is repeatedly usable and accordingly, makes the packaging structure practical and economical for use.

The packaging structure of the present invention can further includes a protective layer 3 provided on an outer side of the packaging portion 1. And, the protective layer 3 is attached to at least the pattern portion 2, as shown in FIGS. 1 and 2. With the protective layer 3, the pattern portion 2 is protected against scratches or color fading.

The packaging portion 1 can be made of a paper material, an aluminum foil material, a plastic material, or any combination thereof. For example, the packaging portion 1 can be directly made of one single material, such as paper, aluminum foil or plastic. Alternatively, the packaging portion 1 can be made of a composite material consisting of an outer paper material and an inner aluminum foil or plastic lining attached to an inner side of the outer paper material, so as to form a composite handbag or to increase the structural strength of the packaging portion 1 according to actual need.

In the first embodiment of the present invention as shown in FIGS. 1 and 2, the two face panels 114 are correspondingly provided with an opening 116 each, which are located in the vicinity of the first opening 112, such that upper portions of the two face panels 114 are formed into two corresponding handles 4. In the first embodiment, the handles 4 are integrally formed with the upper portions of the face panels 114. Reinforcing structures, such as thick cardboards or thick plastic boards (not shown), can be further attached to the same upper portions of the face panels 114 to give the handles 4 increased structural strength. After articles are positioned in the holding space 111, the re-sealable section 13 is sealed to close the first opening 112 and prevent the articles from falling out of the holding space 111. The packaging structure with the packaging portion 1 in the closed state can be conveniently carried using the handles 4 and is very practical for use.

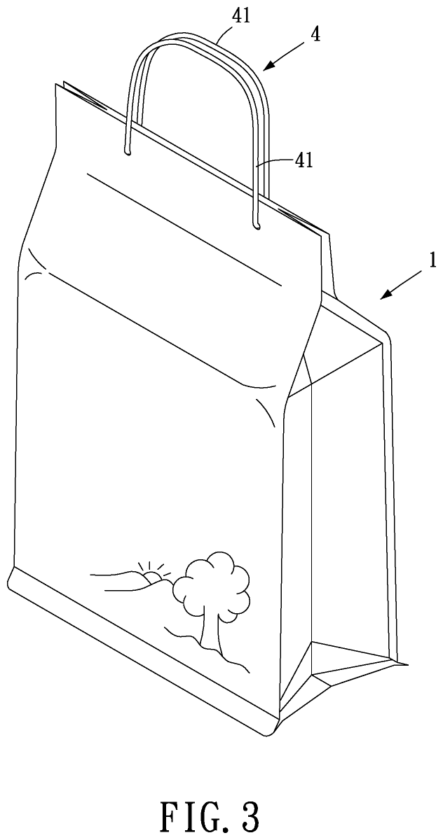

In the second embodiment of the present invention as shown in FIG. 3, the packaging portion 1 is provided at a top with two straps 41, which are located corresponding to each other and form a pair of handles 4. The packaging structure of the present invention can also be conveniently carried using the strap-shaped handles 4.

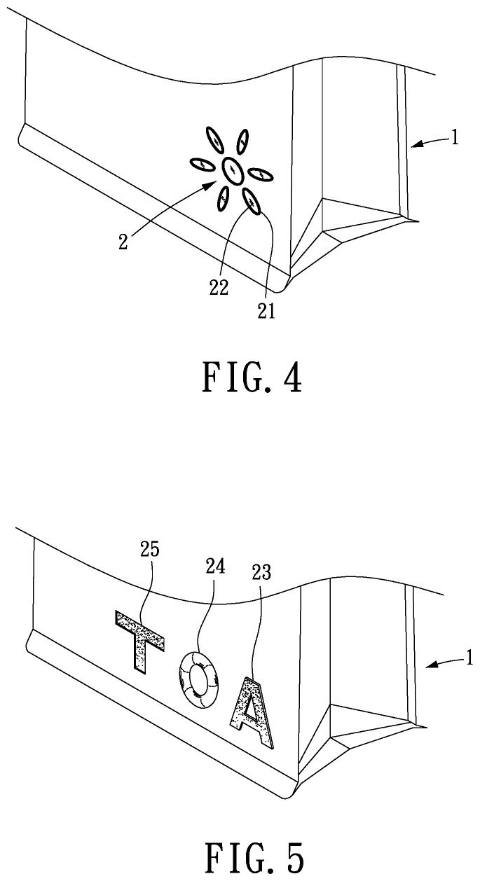

In the third embodiment of the present invention as shown in FIG. 4, the pattern portion 2 includes hollow-out areas 21 formed on the packaging portion 1 by laser cutting.

Meanwhile, the packaging portion 1 is internally provided with at least one sheet of plastic film 22, which closes the hollow-out areas 21 of the pattern portion 2. The hollow-out areas 21 can show texts, numeral numbers, graphics or any combination thereof. Further, in the third embodiment, different colors or graphics presented through multi-color hot foil stamping can be provided around the hollow-out areas 21. In this manner, the pattern portion 2 for the present invention can show different designs according to the requirements in practical applications thereof.

In the fourth embodiment of the present invention as shown in FIG. 5, the pattern portion 2 can include embossed areas 23, extruded areas 24, combined high and low relief areas 25, or any combination thereof. The embossed areas 23 can be one-layer or multi-layer in form and located on the outer surface of the packaging portion 1. The embossed areas 23 can show texts, numeral numbers, graphics or any combination thereof. Further, the embossed patterns 23 can present multiple colors or graphics through hot foil stamping. The extruded areas 24 are three-dimensional patterns protruded from or sunken into the packaging portion 1 formed by squeezing part of the packaging portion 1. Similarly, the extruded areas 24 can show texts, numeral numbers, graphics or any combination thereof. The combined high and low relief areas 25 are three-dimensional patterns formed on the packaging portion 1 by sculpturing the surface of the packaging portion 1. Again, the combined high and low relief areas 25 can show texts, numeral numbers, graphics or any combination thereof. In this manner, the pattern portion 2 for the present invention can show different designs according to the requirements in practical applications thereof.

The present invention has been described with some preferred embodiments thereof and it is understood that the preferred embodiments are only illustrative and not intended to limit the present invention in any way and many changes and modifications in the described embodiments can be carried out without departing from the scope and the spirit of the invention that is intended to be limited only by the appended claims.

1. A packaging structure with patterns formed through continuous multi-color hot foil stamping, comprising:
a packaging portion including a receiving unit and a bottom panel; the receiving unit internally defining at least one holding space and having a first opening and a second opening, which are formed at a top and a bottom of the receiving unit, respectively, and communicable with the at least one holding space; and the bottom panel being an integral one-piece member connected to the bottom of the receiving unit to close the second opening; and
a pattern portion being located on an outer surface of the packaging portion and including continuous multi-color hot foil stamped areas;
wherein, the pattern portion further includes hollow-out areas formed on the packaging portion by laser cutting; and the packaging portion being internally provided with at least one sheet of plastic film for closing the hollow-out areas of the pattern portion;
wherein, the pattern portion further includes embossed areas, combined high and low relief areas, or any combination thereof formed on the outer surface of the packaging portion.

2. The packaging structure as claimed in claim 1, wherein the receiving unit consists of two face panels located opposite to each other and two side panels located opposite to each other; the two side panels being connected at respective two lateral edges to lateral edges of the two face panels; and the bottom panel being connected at its two side edges to lower side edges of the two face panels and at its two end edges to lower end edges of the two side panels, such that the bottom panel closes the second opening of the receiving unit.

3. The packaging structure as claimed in claim 2, wherein joints between the face panels and the side panels are heat sealed; and joints between the bottom panel and the face panels and side panels are also heat sealed.

4. The packaging structure as claimed in claim 1, wherein the packaging portion is internally provided at a position near the first opening with a re-sealable section; and the re-sealable section being selected from the group consisting of a zip lock, a hook-and-loop fastener, a heat-sealable layer and a pair of mating fasteners.

5. The packaging structure as claimed in claim 1, further comprising a protective layer provided on an outer side of the packaging portion; and the protective layer being attached to at least the pattern portion.

6. The packaging structure as claimed in claim 1, wherein the packaging portion is made of a material selected from the group consisting of a paper material, an aluminum foil material, a plastic material, and any combination thereof

7. The packaging structure as claimed in claim 1, wherein the packaging portion is provided in the vicinity of the first opening with at least a pair of handles.

8. The packaging structure as claimed in claim 7, wherein the packaging portion is provided in the vicinity of the first opening with two openings correspondingly facing each other, and the two openings forming the pair of handles.

9. The packaging structure as claimed in claim 7, wherein the packaging portion is provided at a top with two straps, and the two straps forming the pair of handles.

10. (canceled)

11. (canceled)
